(19) United States
(12) Patent Application Publication
(10) Pub. No.: US 2026/0113503 A1
(43) Pub. Date: Apr. 23, 2026

(54) ENABLING ACCESSIBILITY AND SAFETY THROUGH EMBEDDING MACHINE LEARNING SOUND RECOGNITION IN A TELEVISION REMOTE CONTROL

(71) Applicant: AONDEVICES, INC., Irvine, CA (US)

(72) Inventors: Mouna Elkhatib, Irvine, CA (US); Adil Benyassine, Irvine, CA (US); Eli Uc, Irvine, CA (US); George Mansour, Irvine, CA (US)

(21) Appl. No.: 19/362,181

(22) Filed: Oct. 17, 2025

Related U.S. Application Data
(60) Provisional application No. 63/708,607, filed on Oct. 17, 2024.

(51) Int. Cl. H04N 21/422; H04N 21/439; H04N 21/466; H04N 21/488

(52) U.S. Cl. CPC H04N 21/42203; H04N 21/4394; H04N 21/4666; H04N 21/4882

(57) ABSTRACT

A television remote control includes a low-power machine learning (ML) module configured to detect predefined acoustic events such as alarms, infant cries, or doorbells. Upon detection, the system initiates a multi-tiered response including visual alerts on the television, notifications to mobile devices, and optional smart home integration. The system supports accessibility features for users with hearing impairments and may adjust television audio output or enter autonomous modes based on user response. Detection thresholds are refined through adaptive learning based on user feedback. The system operates with minimal power consumption and does not require persistent internet connectivity.

### CROSS-REFERENCE TO RELATED APPLICATIONS

This application relates to and claims the benefit of U.S. Provisional Application No. 63/708,607 filed Oct. 17, 2024 and entitled “METHOD FOR ENABLING ACCESSIBILITY AND SAFETY THROUGH EMBEDDING ML SOUND RECOGNITION IN TV REMOTE CONTROL,” the entire disclosure of which is wholly incorporated by reference herein.

### STATEMENT RE: FEDERALLY SPONSORED RESEARCH/DEVELOPMENT

Not Applicable

### BACKGROUND

### 1. Technical Field

The present disclosure relates generally to human-computer interfaces and machine learning, and more particularly to enabling accessibility and safety through embedding machine learning sound recognition in a television remote control.

### 2. Related Art

Home automation and smart entertainment systems have evolved significantly in recent years, offering features such as voice control, streaming integration, and connectivity with smart home ecosystems. Many households now employ devices capable of detecting environmental conditions or sounds, such as smoke alarms, baby monitors, and doorbell cameras. These devices often use sensors or microphones to capture audio signals and, in some cases, apply basic pattern-matching or cloud-based algorithms to identify specific events.

Sound recognition technologies have also advanced, with machine learning models such as convolutional neural networks (CNNs), recurrent neural networks (RNNs), and deep neural networks (DNNs) being used to classify audio patterns. These models are typically trained on large datasets and deployed in applications ranging from voice assistants to security systems. In consumer electronics, sound detection is commonly implemented in smart speakers or dedicated monitoring devices, which can trigger alerts or automate actions based on detected sounds.

Smart home ecosystems increasingly integrate these capabilities, allowing devices to communicate through cloud platforms or local hubs. For example, a smart speaker may detect a smoke alarm and send a notification to a user's phone, or a baby monitor may stream audio to a mobile app. These systems often rely on continuous connectivity and centralized processing to deliver real-time alerts.

Despite these advancements, current approaches present challenges that impact usability and adoption. Many sound detection systems require dedicated hardware installations, increasing cost and complexity. Devices are often fixed in one location, limiting coverage and necessitating multiple units for whole-home monitoring. Additionally, reliance on always-on internet connectivity raises privacy concerns and can increase power consumption. Finally, existing solutions may not integrate seamlessly with commonly used household devices, such as TV remotes, and often fail to address scenarios where users are wearing headsets, located in different rooms, or away from home.

Furthermore, conventional systems typically lack features that enhance accessibility for users with hearing impairments, such as visual alerts displayed on the television screen. They also do not provide automated environmental adjustments, such as lowering television volume in response to critical sound events, which can improve situational awareness. Most existing solutions do not incorporate adaptive learning mechanisms that refine detection thresholds based on user feedback, nor do they offer autonomous operation modes that modify system behavior without user intervention. Notifications are often limited to mobile devices, excluding users who rely primarily on television screens for information.

The present disclosure addresses these limitations by embedding super-low power machine learning sound recognition directly into a television remote control. This approach enables portable, on-device sound detection with local processing, visual alerts on the television screen, automated volume adjustment, remote notifications, adaptive learning, and autonomous operation, all within a familiar and widely used household device.

### BRIEF SUMMARY

The present disclosure addresses the aforementioned limitations by embedding machine learning-based sound recognition capabilities directly into a television remote control. The remote control is configured to continuously monitor ambient audio for predefined sound events, such as fire alarms, infant distress signals, or doorbells. Machine learning models, including but not limited to convolutional neural networks (CNNs), recurrent neural networks (RNNs), and deep neural networks (DNNs), may be trained offline and deployed to a low-power inference chip, enabling real-time classification of sound events at the edge.

Upon detection of a predefined sound event, the remote control may transmit a signal via Bluetooth to a television set or associated streaming device, which may then relay the event to a cloud-based system. The cloud system may initiate one or more actions, including displaying a visual alert on the television screen or transmitting a push notification to a user's mobile device.

The system further supports accessibility features for users who are deaf or hard of hearing by displaying visual cues or transcripts of the detected sound directly on the television screen. For users wearing headsets, the system ensures that critical sound events are communicated visually, thereby maintaining situational awareness. In scenarios where the user is not in proximity to the television, remote notifications may be delivered via mobile devices to alert the user of the detected event.

The integration of sound recognition into a television remote control offers several advantages over existing solutions. The remote control is a widely used and familiar device and can eliminate the need for additional hardware installations and reduce system cost and complexity. Its portable nature allows flexible placement throughout the home, extending coverage without requiring multiple fixed-location devices. The system may operate without requiring a persistent internet connection, thereby enhancing privacy and reducing power consumption. Furthermore, the remote control may be configured to automatically adjust environmental parameters, such as lowering television volume upon detection of a critical sound event and may operate in an autonomous mode that modifies system behavior without user intervention. Integration with smart home ecosystems enables further automation, such as activating lights or triggering auxiliary alarms, thereby enhancing safety and accessibility.

The present disclosure further introduces a multi-tiered adaptive communication process that can link edge-based acoustic detection within the remote control to coordinated responses across the television set, cloud infrastructure, and mobile devices. Upon detection of a predefined sound event, the remote control may initiate a local response via the television interface, while optionally transmitting data to a cloud-based system for remote notification delivery. This layered architecture enables intelligent system adaptation and ensures user awareness through multiple channels, including visual alerts on the television and push notifications to mobile devices. The system is designed to operate without requiring continuous connectivity or high power consumption, thereby enhancing safety, accessibility, and energy efficiency in a variety of residential environments.

The embedded sound-recognition module may operate as a super-low-power edge classifier within the remote controller, initiating a multi-tier response in which the television provides immediate visual alerts while a cloud service coordinates remote notifications and optional smart-home actions, thereby maintaining user awareness without continuous internet connectivity or high power consumption.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a diagram illustrating an exemplary environment in which various embodiments of the present disclosure may be implemented;

FIG. 2 is a block diagram showing the components of a remote controller utilized in the various embodiments of the present disclosure;

FIG. 3 is a flowchart describing one embodiment of a method for generating alerts through the remote controller in communication with a television set;

FIG. 4 is a flowchart that shows additional details of an exemplary method; and

FIGS. 5A-5C are flowcharts illustrating the various steps of methods for generating alerts through the remote controller.

### DETAILED DESCRIPTION

The detailed description set forth below in connection with the appended drawings is intended as a description of the several presently contemplated embodiments of methods for generating alerts through a remote controller in communication with a television set as well as systems for the same and is not intended to represent the only form in which such embodiments may be developed or utilized. The description sets forth the functions and features in connection with the illustrated embodiments. It is to be understood that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

The embodiments of the present disclosure contemplate the enhancement of home safety and accessibility by embedding machine learning-based sound recognition technology into a television remote control. This system continuously monitors for critical sounds such as fire alarms, baby cries, or doorbells with neural network models optimized for low-power, on-device inference. Upon detecting a predefined sound event, the remote initiates alerts through the television and connected devices, ensuring timely notifications for users, including those who are deaf, hearing-impaired, wearing headsets, or away from home. By leveraging existing household infrastructure, minimizing reliance on internet connectivity, and enabling integration with smart home ecosystems, the embodiments of the present disclosure provides a cost-effective, energy-efficient, and adaptive solution that improves safety, convenience, and inclusivity in everyday living.

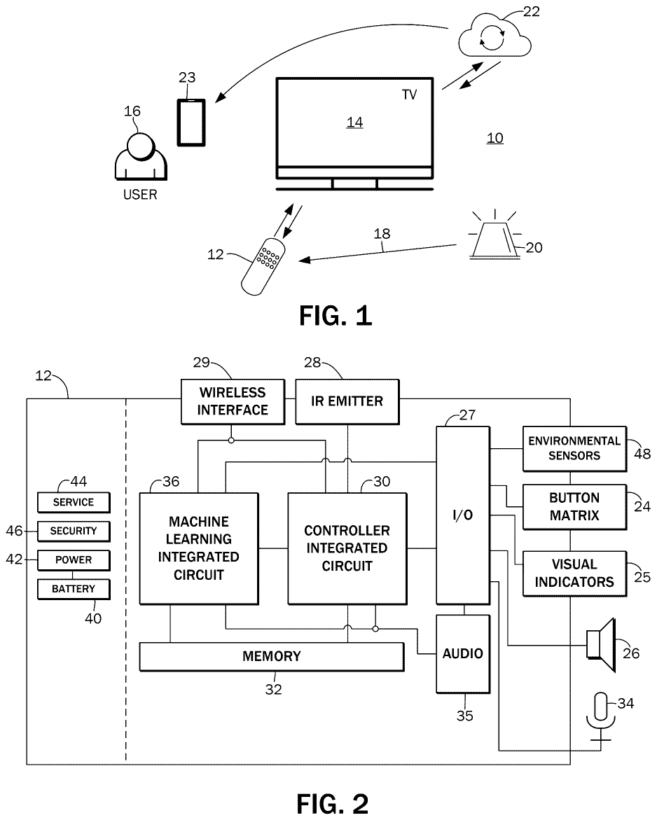

FIG. 1 illustrates an overall system environment 10 in which the various methods of the present disclosure may be utilized. In an exemplary embodiment, there may be a remote controller 12 that is functionally coupled to a television set 14, and may be used to invoke various functional features without a user 16 physically interacting with control inputs directly on the television set 14. These control inputs may include, for example, changing channels, increasing or decreasing the sound volume, and powering up/powering down the television set 14. In addition, and in accordance with various embodiments of the present disclosure, the remote controller 12 may capture a sound event 18 generated by one or more event sources 20. The television set 14 is understood to be connectible to a remote cloud system 22 over the Internet or any other suitable network communications modality. In some instances, where the user 16 does not intervene with event sources 20 or otherwise provide a resolution through the remote controller 12/television set 14, the notification may be escalated to the user mobile device 23.

FIG. 2 illustrates additional details of the remote controller 12, and the most visible and prominent feature being a button matrix 24 that is configured to receive direct user inputs such as channel selection, volume adjustment, and power toggling. The button matrix 24 may be arranged to support tactile feedback and may include dedicated keys for quick access to system functions. Visual indicators 25 may provide status information such as pairing state, battery condition, or alert notifications. An audio transducer 26 may generate tones or other audible cues to confirm user actions or signal system states, and in some embodiments may provide distinct patterns for critical alerts. These may be connected to a unitary input/output interface 27.

An infrared (IR) emitter 28 may be provided to transmit control signals to devices responsive to IR commands, ensuring compatibility with legacy systems. The IR emitter 28 may operate in conjunction with a wireless interface 29 to provide redundant control paths. The wireless interface 29 may support protocols such as Bluetooth® Low Energy or Wi-Fi®, enabling bidirectional data exchange for command signaling and alert notifications. In certain embodiments, the wireless interface 29 may also support encrypted pairing and over-the-air updates.

In some embodiments, the remote controller 12 may transmit the alert signal to the television set 14 via a Bluetooth® communication interface. The wireless interface 29 or Bluetooth module may be configured to operate in a low-power mode and may be activated upon detection of a predefined acoustic event. This enables wireless communication even when the television is in standby or active states.

A controller integrated circuit 30 may manage overall device operation, including processing user inputs, coordinating wireless and IR transmissions, and executing alert signaling logic. To this end, the I/O interface 27, the IR emitter 28, and the wireless interface 29 may be connected to the controller integrated circuit 30. A memory 32 coupled to the controller may store firmware, configuration data, and event logs, and may include secure partitions for sensitive data.

The controller integrated circuit 30 may be a conventional data processing apparatus that may execute pre-programmed instructions that implement the various methods for generating alerts through the remote controller 12 in communication with the television set 14. Specifically, the controller integrated circuit 30 may execute one or more sound-classification models trained to recognize predefined sound events such as alarms, doorbells, or infant cries. Model parameters and detection thresholds may be stored in the memory 32. In some embodiments, the controller integrated circuit 30 may adapt detection thresholds based on contextual data received from the controller. The controller integrated circuit 30 may further implement adaptive behaviors such as escalating alerts to the television set 14 or the user mobile device 23 when no user response is detected, as will be described in further detail below.

One or more microphones 34 may be provided to capture acoustic signals from the surrounding environment. Where analog microphones 34 are employed, an audio interface 35 or front end may provide amplification, filtering, and automatic gain control to improve signal quality. The audio interface 35 may also digitize the conditioned signals or perform PDM-to-PCM conversion for digital microphones 34. The I/O interface 27 may provide the physical/electrical interface to the output lines to the audio transducer 26 and the input lines from the microphones 34, which relays the signals between the audio interface 35.

In some embodiments, the basic television set operation functions as well as the machine learning and functions may both handled solely by the controller integrated circuit 30, this is by way of example only and not of limitation. In a preferred, though optional embodiment, there may be a machine learning integrated circuit 36 that executes the aforementioned sound classification models and implement adaptive behaviors. Thus, the memory 32 may be accessed by the machine learning integrated circuit 36 as well. In some embodiments, the machine learning integrated circuit 36 may comprise, or includes, a neural processing unit (NPU) configured to execute sound-classification neural networks with sub-milliwatt average power in an always-listening mode. As used herein, “NPU” encompasses dedicated neural-inference accelerators and low-power edge-inference devices, including devices such as the AON1100, functionally equivalent to the machine learning integrated circuit 36 described herein. This example is provided to illustrate a suitable class of hardware and is not limiting.

A battery 40 may supply power to the remote controller 12 and its constituent components, and a power management integrated circuit 42 may regulate voltages to the controller integrated circuit 30, wireless interface 29, and other functional blocks. The power management integrated circuit 42 may support low-power modes, battery charging, and protection features such as over-current and thermal safeguards. A clocking subsystem may provide timing references for the controller and communication interfaces. A service interface 44 may allow firmware updates and device provisioning through a wired connection.

A hardware security module 46 may store cryptographic keys, verify software authenticity, and enforce secure boot procedures. These features ensure that firmware and model updates received from a host or cloud service are authenticated prior to installation. In some embodiments, the security module may also manage encrypted communications between the remote controller 12 and external devices.

Environmental sensors 48 connected through the I/O interface 27 may provide data such as motion or ambient noise levels to optimize power states or enhance system responsiveness. These enhancements may include, for example, by waking the device when motion is detected or adjusting sensitivity based on background conditions.

The foregoing description is illustrative of representative components and their functional relationships; variations in component selection and partitioning are contemplated without departing from the scope of the present disclosure.

In some embodiments, the system implements a bidirectional configuration channel between the television set 14 and the remote controller 12. Responsive to an on-screen user input rendered by the television set (e.g., acknowledgement, dismissal, or selection of a configuration option associated with a detected event), the television set 14 is operable to transmit a configuration instruction to the remote controller 12 via the wireless interface 29. The configuration instruction may include, without limitation: (i) a class-specific directive to temporarily or permanently suppress notifications for a designated sound class; (ii) a directive to ignore specific sound instances for a dwell period; (iii) a threshold adjustment for one or more detection classes; and/or (iv) a modification of persistence windows and debounce intervals for event qualification.

Upon receipt of the configuration instruction, the controller integrated circuit 30 of the remote controller 12 writes corresponding parameters to a memory accessible to the machine learning integrated circuit 36, thereby reconfiguring on-device detection behavior without requiring physical interaction with the remote controller 12. The configuration instruction may be authenticated and encrypted using credentials stored in a hardware security module 46 of either device. In certain implementations, the television set 14 may surface a user interface that presents actionable controls (e.g., “Ignore doorbell alerts for 30 minutes”, “Reduce sensitivity to infant cry at night hours”, “Stop alerts for this sound class”), enabling television-driven tuning of the embedded sound detector within the remote controller 12. This bidirectional configuration interface facilitates a closed-loop adaptation in which user actions at the television directly influence the remote controller's detection pipeline, reducing nuisance alerts and aligning the system with user preferences over time.

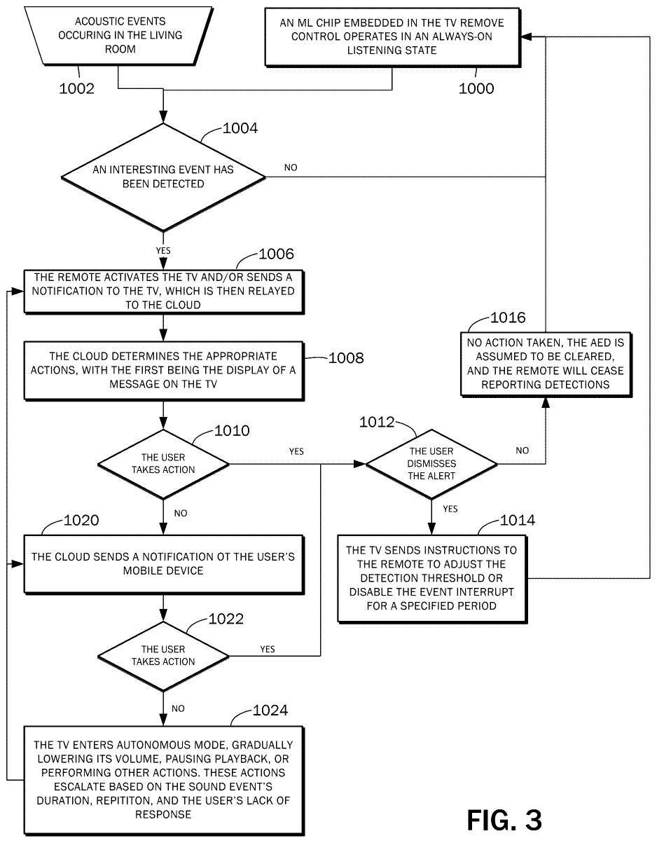

FIG. 3 illustrates a flowchart of an exemplary method for generating alerts through a remote controller 12 in communication with the television set 14. The method begins at step 1000, where the remote controller 12 enters an always listening monitoring state. In this state, the power management integrated circuit 42 supplies a low power rail to the machine learning integrated circuit 36 while maintaining the controller integrated circuit 30 in a reduced power condition. The microphones 34 continuously capture acoustic signals from the surrounding environment, and at step 1002, these signals are conditioned by the audio interface 35 through amplification, filtering, and automatic gain control. The audio interface 35 converts the conditioned signals into a digital stream suitable for classification. The machine learning integrated circuit 36 analyzes the digitized audio stream using one or more sound classification models stored in memory 32, computing confidence values and persistence estimates for predefined sound events such as alarms, doorbells, or infant cries.

At decision block 1004, a determination is made as to whether any predefined sound event meets or exceeds a confidence threshold. If the determination is negative, the method returns to step 1000 to continue monitoring. If the determination is affirmative, persistence and contextual verification may be applied over a configurable duration to reduce false positives. As part of decision block 1004, the machine learning integrated circuit 36 evaluates whether the candidate event remains present for at least a defined time window and may incorporate readings from environmental sensors 48 to adjust sensitivity within bounds stored in memory 32. Upon satisfaction of these criteria, the machine learning integrated circuit 36 asserts a wake signal to the controller integrated circuit 30, and the power management integrated circuit 42 transitions the controller integrated circuit 30 and relevant interfaces to an active state. The controller integrated circuit 30 constructs an alert payload including the detected event class, time stamp, confidence value, and persistence indication, initializes the wireless interface 29, and, where applicable, prepares the IR emitter 28 for legacy activation.

At step 1006, the alert is transmitted to the television set 14. If the television set 14 is in a standby or powered-off mode, the transmission includes a wake command to activate the display of an alert. If the television set 14 is already active, the alert payload is conveyed via the wireless interface 29. Upon receiving the alert signal, system-on-chip (SoC) of the television set 14 may process the detection event and initiate communication with the remote cloud system 22 via a Wi-Fi or Ethernet connection. The SoC may encapsulate the event metadata and transmit it securely to the cloud for further processing, notification delivery, or system configuration updates. The remote controller 12 provides local feedback via the visual indicators 25 and the audio transducer 26 to signal that a critical event has been detected. The alert may also be relayed to the remote cloud system 22, and at step 1008, the remote cloud system 22 determines next actions based on the event class and elapsed time since detection. One contemplated possibility is the display of a message on the television set 14.

In some embodiments, the television set 14 may display visual cues to assist users with hearing impairments. These cues may include, but are not limited to, flashing borders around the screen, pop-up messages indicating the nature of the detected sound event, or a textual transcript of the sound (e.g., “Smoke alarm detected” or “Baby crying”). These visual indicators may be overlaid on the current video content or presented as full-screen alerts, depending on the severity of the detected event and user preferences.

In scenarios where the television audio is routed through a headset—such as Bluetooth headphones or wired earphones—the system may automatically prioritize visual alerts on the television screen. This ensures that users who are wearing headsets and may not hear ambient sounds or audio alerts are still notified of critical acoustic events through visual means.

In certain embodiments, the television set 14 may automatically adjust its audio output in response to the detection of a predefined sound event. Such adjustments may include lowering the volume, muting the audio, or pausing media playback. These actions are intended to reduce auditory masking of critical environmental sounds and to draw the user's attention to the alert. The specific response may be configurable based on the type of detected event and user preferences.

The remote controller 12 may determine the operational state of the television set 14 and select the appropriate communication protocol accordingly. If the television set 14 is in a powered-off or standby state, the remote controller 12 may use infrared (IR) signaling to wake the television. If the television set 14 is already powered on, the remote may use Bluetooth® communication to transmit the alert payload to the SoC of the television set 14.

At decision block 1010, a determination is made within a first timeout interval as to whether external user intervention relative to the detected event is observed, such as cessation of the sound event at its source. If intervention is detected, the method proceeds to await a dismissal input from the user through the button matrix 24 for an alert dismissal timeout period while maintaining onscreen and local alerts.

At decision block 1012, a determination is made as to whether a dismissal input has been received within the alert dismissal timeout. If affirmative, the method proceeds to step 1014, where an adaptive update is applied to detection parameters. The controller integrated circuit 30 writes one or more class-specific threshold adjustments for the machine learning integrated circuit 36 to memory 32, records event metadata, instructs the television set 14 to clear the onscreen alert, and returns to a reduced power condition under control of the power management integrated circuit 42. Monitoring resumes at step 1000. If no dismissal input is received at decision block 1012, no further action is taken in accordance with step 1016, where the event is assumed cleared and the remote controller 12 ceases reporting detections and resumes detection following the elapse of the alert dismissal timeout.

Returning to decision block 1010, if within the first timeout interval the user does not take action such as cessation of the sound event at its source, escalation occurs and the method advances to step 1020, where an event notification is transmitted to the remote cloud system 22 via the wireless interface 29. The controller integrated circuit 30 may authenticate and encrypt the transmission using credentials stored in the hardware security module 46. The remote cloud system 22 forwards a notification to the user mobile device 23.

In some embodiments, the user may receive a push notification on the user mobile device 23 via a companion application. The application may allow the user to acknowledge or dismiss the alert, and such feedback may be transmitted to the remote cloud system 22. The remote cloud system 22 may then update configuration parameters, such as detection thresholds or alert suppression intervals, which are relayed back to the television set 14 and remote controller 12 to refine future detection behavior

In response to the notification sent to the user mobile device 23, the user may take action to resolve sound event at its source. In a decision block 1022, the determination is made whether such intervention occurs within the same timeout interval. If so, the method proceeds to the decision block 1012, discussed above. Otherwise, the method advances to a step 1024, where the television set 14 may optionally transition into an autonomous mode in which the television set 14 performs a sequence of actions without user intervention based on continued event persistence and lack of dismissal, including progressively lowering volume, pausing playback, and renewing the on-screen alert at defined intervals. In some embodiments, transmission to the user mobile device 23 occurs only after a configurable sequence of local alert actions on the television set 14 remains unacknowledged for a predefined duration. The method may involve further escalation by sending an additional alert to the television set as per step 1006, or sending an additional alert to from the remote cloud system 22 to the user mobile device 23 as per step 1020.

In another embodiment, event-sequence gating may be applied to reduce unnecessary television activation for transient or contextually irrelevant sounds. By way of example and not limitation, responsive to detection of a doorbell class event by the machine learning integrated circuit 36, the system executes a sequence of follow-up checks to confirm situational relevance prior to presenting an on-screen alert or waking a television from a low-power state. The sequence may include: (i) monitoring for footstep acoustic signatures within a bounded interval following the doorbell event; (ii) evaluating human presence using motion or proximity sensors associated with the remote controller or the television; and (iii) determining a television operational state (e.g., powered-off, standby, or active playback). If the sequence is not satisfied (e.g., no footsteps are detected, no presence is indicated, and the television is already powered off), the system suppresses alert generation and television activation for the doorbell event and returns to monitoring. Sequence criteria and timing windows are configurable, and class-specific variations may be stored in memory and updated via the configuration channel described herein. This event-sequence gating paradigm may be generalized to other classes, such as confirming alarm persistence above a minimum duration and optionally corroborating with ambient noise levels prior to initiating escalation or autonomous actions.

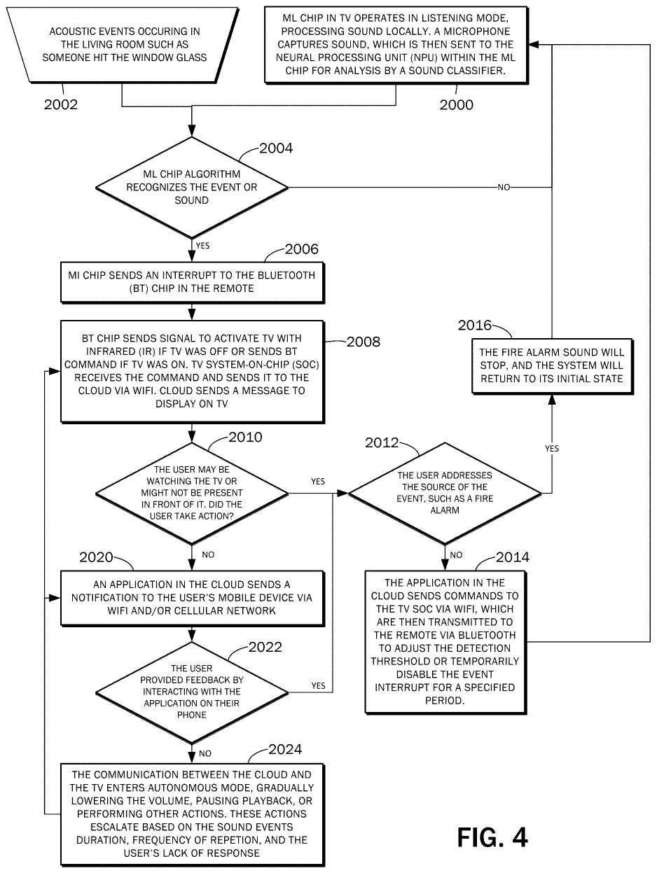

FIG. 4 illustrates a flowchart of a more specific, exemplary embodiment of the method broadly described with reference to FIG. 3. The blocks shown in FIG. 4 correspond to the functional stages of FIG. 3, but provide additional detail regarding television activation, cloud interaction, and autonomous mode behavior.

At step 2000, corresponding to step 1000 of FIG. 3, the remote controller 12 enters an always listening monitoring state. The power management integrated circuit 42 supplies a low-power rail to the machine learning integrated circuit 36 while maintaining the controller integrated circuit 30 in a reduced power condition. The microphones 34 capture acoustic signals from the surrounding environment, and the audio interface 35 applies amplification, filtering, and automatic gain control before converting the conditioned signals into a digital stream.

At step 2002, corresponding to step 1002 of FIG. 3, the machine learning integrated circuit 36 analyzes the digitized audio stream using one or more sound classification models stored in memory 32. These models compute confidence values and persistence estimates for predefined sound events such as alarms, doorbells, or infant cries.

At decision block 2004, corresponding to decision block 1004 of FIG. 3, a determination is made as to whether any predefined sound event meets or exceeds a confidence threshold. If the determination is negative, the method returns to step 2000 to continue monitoring. If affirmative, persistence and contextual verification may be applied over a configurable duration to reduce false positives. The machine learning integrated circuit 36 may incorporate readings from environmental sensors 48 to adjust sensitivity within bounds stored in memory 32. Upon satisfaction of these criteria, the machine learning integrated circuit 36 asserts a wake signal to the controller integrated circuit 30, and the power management integrated circuit 42 transitions the controller and relevant interfaces to an active state.

At step 2006, corresponding to step 1006 of FIG. 3, the controller integrated circuit 30 constructs an alert payload including the detected event class, time stamp, confidence value, and persistence indication. The controller integrated circuit 30 initializes the wireless interface 29 and, where applicable, prepares the IR emitter 28 for legacy activation. If the television set 14 is in a standby or powered off mode, the transmission includes a wake command via infrared signaling; otherwise, the alert is transmitted via the wireless interface 29.

At step 2008, corresponding to step 1008 of FIG. 3, the television set 14 receives the alert and initiates a local response. This may include activating the display to present a visual alert or a text transcript of the detected sound event. Concurrently, the television set 14 establishes a connection to the remote cloud system 22 via Wi-Fi and forwards the event data for remote processing.

At decision block 2010, corresponding to decision block 1010 of FIG. 3, a determination is made as to whether the user has acknowledged or dismissed the alert within a predefined timeout interval. If acknowledgment occurs, the system returns to monitoring at step 2000. If no acknowledgment occurs, the method proceeds to decision block 2012.

At decision block 2012, corresponding to decision block 1012 of FIG. 3, the system awaits a dismissal input from the user through the button matrix 24 for an alert-dismissal timeout period while maintaining on-screen and local alerts. If affirmative, the method proceeds to step 2014; otherwise, the method advances to step 2016.

At step 2014, corresponding to step 1014 of FIG. 3, an adaptive update is applied to detection parameters. The controller integrated circuit 30 writes one or more class-specific threshold adjustments for the machine learning integrated circuit 36 to memory 32, records event metadata, instructs the television set 14 to clear the on-screen alert, and returns to a reduced-power condition under control of the power management integrated circuit 42. Monitoring resumes at step 2000.

At step 2016, corresponding to step 1016 of FIG. 3, the event is treated as cleared based on cessation at the source, and the remote controller 12 ceases reporting detections associated with the cleared event.

Returning to decision block 2010, if within the first timeout interval the user does not take action such as cessation of the sound event at its source, escalation occurs and the method advances to step 2020, corresponding to step 1020 of FIG. 3. At this step, an event notification is transmitted to the remote cloud system 22 via the wireless interface 29. The controller integrated circuit 30 may authenticate and encrypt the transmission using credentials stored in the hardware security module 46. The remote cloud system 22 forwards a notification to the user mobile device 23.

At decision block 2022, corresponding to decision block 1022 of FIG. 3, a determination is made whether user intervention occurs within the same timeout interval. If affirmative, the method proceeds to decision block 2012 to process any dismissal input and, upon affirmative dismissal, to step 2014 for adaptive update and restoration to the monitoring state under step 2000. Otherwise, the method advances to step 2024, corresponding to step 1024 of FIG. 3, where the television set 14 may optionally transition into an autonomous mode in which the television set 14 performs a sequence of actions without user intervention based on continued event persistence and lack of dismissal. These actions may include progressively lowering volume, pausing playback, and renewing the on-screen alert at defined intervals. Configuration instructions originating from the remote cloud system 22 may be propagated to the television set 14 and, where applicable, relayed to the remote controller 12 via the wireless interface 29 to temporarily adjust class-specific detection thresholds in memory 32 or to suppress repeated event interrupts for a defined dwell period, after which the thresholds and interrupt conditions are restored for continued monitoring beginning at step 2000.

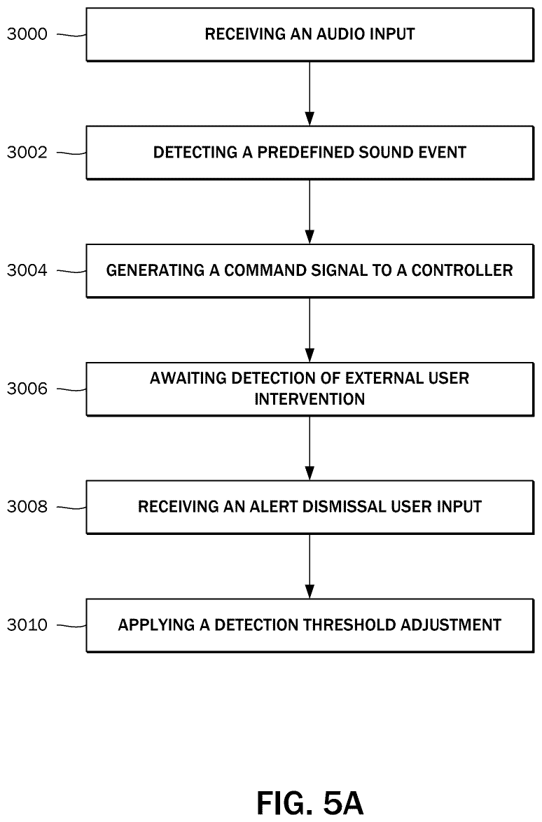

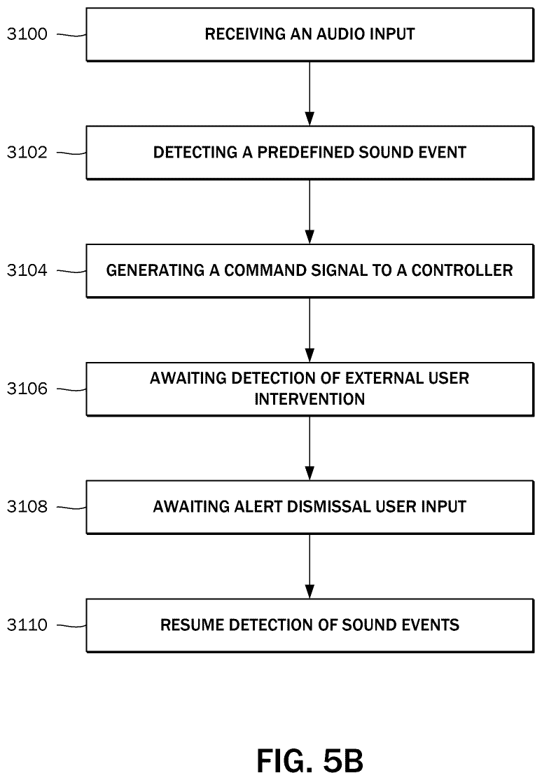

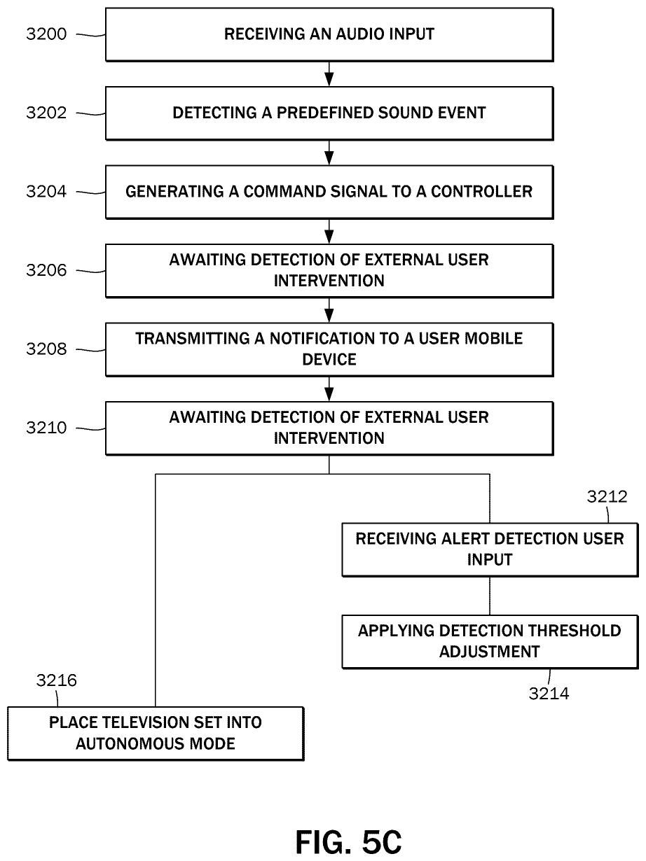

The operational flows described with reference to FIGS. 3 and 4 illustrate exemplary implementations of the disclosed methods. For clarity and completeness, FIG. 5A-5C present additional flowchart representations that organize the method steps in a structured sequence corresponding to the functional stages previously discussed. These figures provide an alternative depiction of the same underlying operations, expressed in a manner that emphasizes the logical progression of actions and decisions. The following description explains each step and decision block with reference to the components identified in FIG. 2 and the broader context of FIGS. 3 and 4.

With reference to FIG. 5A, one embodiment of the method begins with a step 3000, in which an audio input is received through at least one microphone 34 integrated into the remote controller 12. The audio input may be conditioned by an audio interface 35 to yield a digitized signal stream for classification. As illustrated in FIG. 3 at step 1000, the microphones 34 continuously capture acoustic signals while the audio interface 35 applies amplification, filtering, and automatic gain control before conversion into a digital stream suitable for analysis.

Next, at step 3002, the method continues with detecting a predefined sound event based upon the audio input using an embedded machine learning integrated circuit 36 in the remote controller 12. The machine learning integrated circuit 36 operates in an always-listening low-power mode and applies one or more sound-classification models to compute confidence values and persistence estimates for predefined sound events such as alarms, doorbells, or infant cries, as described in FIG. 3 at step 1002. In some embodiments, this detection comprises performing on-device inference with a neural network, which may be a convolutional neural network, a recurrent neural network, and deep neural networks, and combinations thereof, thereby enabling efficient edge processing without reliance on cloud connectivity. These models are trained offline on datasets of predefined acoustic events and deployed to the machine learning integrated circuit 36 for on-device inference. The machine learning integrated circuit 36 operates in an always-on mode, enabling continuous monitoring without requiring persistent wireless connectivity or high-power processing resources.

Thereafter, the method may include a step 3004 of generating, in response to the detection of the predefined sound event, a command signal to a controller integrated circuit 30 embedded in the remote controller 12 and separate from the embedded machine learning integrated circuit 36. This initiates transmission of an alert to the television set 14 for display. The controller constructs an alert payload including event metadata and activates the wireless interface 29 and, where applicable, the IR emitter 28 to transmit the alert. If the television is in standby, the IR emitter 28 sends a wake command; otherwise, the alert is conveyed via wireless signaling. The television set 14 is activated and displays a corresponding alert, consistent with FIG. 3 at step 1006. In some embodiments, displaying the alert further comprises presenting a text transcript corresponding to the sound event on the television set 14, thereby enhancing accessibility for hearing-impaired users.

At a step 3006, the method involves awaiting the detection of an external user intervention relative to the predefined sound event negating the detection of the predefined sound event until a timeout period elapses. During this interval, the system monitors for cessation of the sound event at its source, as shown in decision block 1010 of FIG. 3. In certain embodiments, responsive to detecting a sound event, the system evaluates a sequence of follow-up checks comprising at least one additional condition associated with the sound event and suppresses the alert when the sequence does not satisfy predefined criteria, thereby reducing false positives.

The method continues with a step 3008 of receiving an alert dismissal user input from the remote controller 12 following the detection of the external user intervention. The input is entered via the button matrix 24 of the remote controller 12 to acknowledge and clear the alert condition presented on the television set 14, corresponding to decision block 1012 in FIG. 3.

Thereafter, at step 3010, there is a step of applying a detection threshold adjustment to the embedded machine learning integrated circuit 36. The controller modifies class-specific sensitivity parameters stored in memory 32 to refine future detection behavior, as described in FIG. 3 at step 1014, before returning the system to a reduced-power monitoring state. In some embodiments, applying the detection threshold adjustment comprises modifying a threshold detection value based at least in part on contextual parameters such as ambient noise or time-of-day, and may further comprise modifying a detection threshold specific to a class of the sound event without affecting thresholds for other sound event classes.

With reference to FIG. 5B, another embodiment of the method begins with a step 3100 of receiving an audio input through at least one microphone 34 integrated into the remote controller 12. The audio input may be conditioned by an audio interface 35 to yield a digitized signal stream for classification. As illustrated in FIG. 3 at step 1000, the microphones 34 continuously capture acoustic signals while the audio interface 35 applies amplification, filtering, and automatic gain control before conversion into a digital stream suitable for analysis.

The method continues with a step 3102 of detecting a predefined sound event based upon the audio input. Again, this may be achieved with the embedded machine learning integrated circuit 36 in the remote controller 12. As indicated above, the machine learning integrated circuit 36 operates in an always-listening low-power mode and applies one or more sound-classification models to compute confidence values and persistence estimates for predefined sound events as described in FIG. 3 at step 1002. In some embodiments, this detection comprises performing on-device inference with a neural network.

In accordance with various embodiments of the present disclosure, the method may also include a step 3104 of generating a command signal to a controller integrated circuit 30 that is embedded in the remote controller 12 and separate from the embedded machine learning integrated circuit 36. This may be in response to the detection of the sound event. The command signal initiates transmission of an alert to the television set 14. The controller constructs an alert payload including event metadata and activates the wireless interface (29) and, where applicable, the IR emitter (28) to transmit the alert. If the television is in standby, the IR emitter 28 sends a wake command; otherwise, the alert is conveyed via wireless signaling. The television set 14 is activated and displays the alert, consistent with FIG. 3 at step 1006.

The method contemplates a step 3106 of awaiting, until a timeout period elapses, the detection of an external user intervention relative to the sound event negating the detection thereof. During this interval, the system monitors for cessation of the sound event at its source, as shown in decision block 1010 of FIG. 3. At a step 3108, the method involves awaiting an alert dismissal user input until an alert dismissal timeout period elapses. The system maintains onscreen and local alerts during this interval, corresponding to decision block 1012 in FIG. 3.

The detection of sound events may resume in accordance with a step 3110 based upon the audio input, following elapse of the alert dismissal timeout period. The controller returns the system to a reduced-power monitoring state under control of the power management integrated circuit 42, as described in FIG. 3 at step 1016.

With reference to FIG. 5C, another embodiment of the method begins with a step 3200 of receiving an audio input through at least one microphone 34 integrated into the remote controller 12. The audio input may be conditioned by the audio interface 35 to yield a digitized signal stream for classification. As illustrated in FIG. 3 at step 1000, the microphones 34 continuously capture acoustic signals while the audio interface 35 applies amplification, filtering, and automatic gain control before conversion into a digital stream suitable for analysis.

The method continues with a step 3202 of detecting, with an embedded machine learning integrated circuit 36 in the remote controller 12, a predefined sound event based upon the audio input. The machine learning integrated circuit 36 operates in an always-listening low-power mode and applies one or more sound-classification models to compute confidence values and persistence estimates for predefined sound events as described in FIG. 3 at step 1002. In some embodiments, detecting the event comprises performing on-device inference with a neural network.

At step 3204, the method includes a step of generating a command signal to a controller integrated circuit 30 embedded in the remote controller 12 that is separate from the embedded machine learning integrated circuit 36. This step may take place in response to the detection of the event. The command signal also initiates the transmission of an alert to the television set 14. The controller constructs an alert payload including event metadata and activates the wireless interface 29 and, where applicable, the IR emitter 28 to transmit the alert. If the television is in standby, the IR emitter 28 sends a wake command; otherwise, the alert is conveyed via wireless signaling. The television set 14 is activated and displays the alert, consistent with FIG. 3 at step 1006.

The method may proceed to a step 3206 of awaiting the detection of an external user intervention relative to the event negating the detection of the event. This continues until a timeout period elapses. During this interval, the system monitors for cessation of the sound event at its source, as shown in decision block 1010 of FIG. 3.

The embodiments of the method may also include step 3208 of transmitting a notification to a user mobile device 23 from the remote cloud system 22. This occurs following elapse of the timeout period. The controller integrated circuit 30 authenticates and encrypts the transmission using credentials stored in the hardware security module 46, and the cloud system forwards the notification to the mobile device, consistent with FIG. 3 at step 1020. In some embodiments, transmitting the notification occurs only after the television set 14 performs a configurable sequence of local alert actions that remain unacknowledged for a predefined duration.

The method further includes a step 3210 of awaiting the detecting of an external user intervention relative to the event negating the detecting of the event until another timeout period elapses. If intervention is detected, the system proceeds to receive an alert dismissal input. At a step 3212, the alert dismissal user input is received following the detecting of the external user intervention. The input may be entered via the button matrix 24 of the remote controller 12 to acknowledge and clear the alert condition presented on the television set 14. Next, at step 3214, the method continues with applying a detection threshold adjustment to the embedded machine learning integrated circuit 36.

The controller may modify class-specific sensitivity parameters stored in memory 32 to refine future detection behavior, as described in FIG. 3 at step 1014, before returning the system to a reduced-power monitoring state. In some embodiments, applying the detection threshold adjustment comprises modifying a threshold detection value based at least in part on contextual parameters and may further comprise modifying a detection threshold specific to a class of the sound event without affecting thresholds for other sound event classes.

The method may also include a step 3216 of placing the television set 14 into an autonomous mode following elapse of the timeout period. Functionality of the remote system may be modified without user intervention in the autonomous mode. In this mode, the television set 14 automatically reduces playback volume, pauses playback, or performs a sequence of actions based on persistence of the event and absence of user dismissal, the sequence comprising at least two of reducing volume, pausing playback, and forwarding the alert to the remote cloud system 22, as described in FIG. 3 at step 1024.

The foregoing embodiments are readily extensible to additional acoustic event classes beyond the illustrative alarms, doorbells, and infant distress signals. In certain embodiments, the machine learning integrated circuit 36 executes models trained to recognize water leak signatures (e.g., continuous dripping, pooling), glass break transients characterized by broadband impulsive spectra, and other user-relevant sounds. In further embodiments, the system supports custom sound profiles, wherein a user enrolls a bespoke acoustic pattern through a training workflow and deploys the resulting model parameters to the remote controller 12 for on-device inference. Custom profiles may be enabled or disabled per schedule, location context, or television state, and may be associated with class-specific alert modalities and escalation policies.

Support for additional classes and custom profiles can be implemented without changes to the physical architecture of the remote controller 12, leveraging the existing microphones 34, audio front end, controller integrated circuit 30, and wireless interface 29 for model deployment and parameter updates. To preserve privacy and energy efficiency, custom profiles may be executed entirely on-device, with optional cloud backup of model parameters subject to user consent.

In some embodiments, the system may be integrated with smart home ecosystems. Upon detection of a predefined sound event, the television set 14 or remote cloud system 22 may transmit control signals to one or more smart home devices. These signals may initiate actions such as turning on lights, triggering auxiliary alarms, or sending notifications to other smart devices (e.g., smart speakers, thermostats, or security systems). This integration enhances situational awareness and safety, particularly in emergency scenarios.

The system architecture supports a multi-tiered adaptive communication process that begins with edge-based acoustic detection in the remote controller 12. Upon detection of a sound event, the remote controller 12 initiates a local response via the television interface. Simultaneously or subsequently, the television may communicate with the remote cloud system 22 to synchronize event data and trigger remote notifications. This architecture ensures that alerts are delivered through multiple channels, from the television display, mobile notifications, to smart home devices, while maintaining energy efficiency and user privacy. The system is designed to function effectively even in the absence of continuous internet connectivity, relying on local processing and deferred cloud communication when necessary.

The particulars shown herein are by way of example and for purposes of illustrative discussion of the embodiments of for generating alerts through a remote controller in communication with a television set and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. A method for generating alerts through a remote controller in communication with a television set, the method comprising:
receiving an audio input through a microphone on the remote controller;
detecting, using an embedded machine learning integrated circuit in the remote controller, a predefined sound event based upon the audio input;
generating, in response to the detection of the predefined sound event, a command signal to a controller integrated circuit embedded in the remote controller and separate from the embedded machine learning integrated circuit, the command signal initiating a transmission of an alert to the television set for display, the television set being activated in response to receipt of the alert and display a corresponding alert;
awaiting, until a timeout period elapses, the detection of an external user intervention relative to the predefined sound event negating the detection of the predefined sound event;
receiving an alert dismissal user input from the remote controller following the detection of the external user intervention; and
applying a detection threshold adjustment to the embedded machine learning integrated circuit.

2. The method of claim 1, wherein detecting the sound event comprises performing, on the remote controller, on-device inference with a neural network selected from the group consisting of: a convolutional neural network, a recurrent neural network, and deep neural networks, and combinations thereof.

3. The method of claim 1, wherein the embedded machine learning integrated circuit operates in an always-listening low-power mode and awakens the controller integrated circuit in response to the detecting of the sound event.

4. The method of claim 1, wherein displaying the alert further comprises presenting a text transcript corresponding to the sound event on the television set.

5. The method of claim 1, further comprising, responsive to detecting a sound event, evaluating a sequence of follow-up checks comprising at least one additional condition associated with the sound event; and suppressing the alert when the sequence of follow-up checks does not satisfy predefined criteria.

6. The method of claim 1, wherein detecting the predefined sound event includes confirming that the sound event persists for at least a configurable duration prior to initiating the transmission of the alert.

7. The method of claim 1, wherein applying the detection threshold adjustment comprises modifying a threshold detection value based at least in part on contextual parameters.

8. The method of claim 1, wherein applying the detection threshold adjustment comprises modifying a detection threshold specific to a class of the sound event without affecting thresholds for other sound event classes.

9. A method for generating alerts through a remote controller in communication with a television set, the method comprising:
receiving an audio input through a microphone on the remote controller;
detecting, with an embedded machine learning integrated circuit in the remote controller, a predefined sound event based upon the audio input;
generating, in response to the detection of the sound event, a command signal to a controller integrated circuit embedded in the remote controller and separate from the embedded machine learning integrated circuit, the command signal initiating a transmission of an alert to the television set, the television set being activated in response to receipt of the alert and display of the alert;
awaiting, until a timeout period elapses, the detection of an external user intervention relative to the sound event negating the detection thereof;
awaiting, until an alert dismissal timeout period elapses, an alert dismissal user input; and
resuming detection of sound events based upon the audio input following elapse of the alert dismissal timeout period.

10. The method of claim 9, wherein detecting the sound event comprises performing, on the remote controller, on-device inference with a neural network selected from the group consisting of: a convolutional neural network, a recurrent neural network, and deep neural networks, and combinations thereof.

11. The method of claim 9, wherein the embedded machine learning integrated circuit operates in an always-listening low-power mode and awakens the controller integrated circuit in response to the detecting of the predefined sound event.

12. A method for generating alerts through a remote controller in communication with a television set, the method comprising:
receiving an audio input through a microphone on the remote controller;
detecting, with an embedded machine learning integrated circuit in the remote controller, a predefined sound event based upon the audio input;
generating, in response to the detection of the event, a command signal to a controller integrated circuit embedded in the remote controller and separate from the embedded machine learning integrated circuit, the command signal initiating a transmission of an alert to the television set, the television set being activated in response to receipt of the alert and display the alert;
awaiting, until a timeout period elapses, the detection of an external user intervention relative to the event negating the detection of the event; and
transmitting, from a remote cloud system, a notification to a user mobile device following elapse of the timeout period.

13. The method of claim 12, further comprising:
awaiting, until another timeout period elapses, the detecting of an external user intervention relative to the event negating the detecting of the event;
receiving an alert dismissal user input following the detecting of the external user intervention; and
applying a detection threshold adjustment to the embedded machine learning integrated circuit.

14. The method of claim 13, further comprising:
placing the television set into an autonomous mode following elapse of the timeout period, functionality of the television set being modified without user intervention in the autonomous mode.

15. The method of claim 14, wherein in the autonomous mode, the television set automatically reduces playback volume.

16. The method of claim 14, wherein in the autonomous mode, the television set automatically pauses playback.

17. The method of claim 14, wherein in the autonomous mode, the television set performs a sequence of actions based on persistence of the event and absence of user dismissal, the sequence comprising at least two of: reducing volume, pausing playback, and forwarding the alert to the remote cloud system.

18. The method of claim 12, wherein transmitting the notification to the user mobile device occurs only after the television set performs a configurable sequence of local alert actions that remain unacknowledged for a predefined duration.

19. The method of claim 12, wherein detecting the event comprises performing, on the remote controller, on-device inference with a neural network selected from the group consisting of: a convolutional neural network, a recurrent neural network, and deep neural networks, and combinations thereof.

20. The method of claim 12, wherein the embedded machine learning integrated circuit operates in an always-listening low-power mode and awakens the controller integrated circuit in response to the detecting of the sound event.
